(19) United States
(12) Patent Application Publication
(10) Pub. No.: US 2017/0241573 A1
(43) Pub. Date: Aug. 24, 2017

(54) Hose Bib System

(71) Applicant: William Kemp, Austin, TX (US)

(72) Inventor: William Kemp, Austin, TX (US)

(21) Appl. No.: 15/049,128

(22) Filed: Feb. 21, 2016

(51) Int. Cl. F16L 5/10; F16L 15/00; F16L 33/207

(52) U.S. Cl. CPC F16L 5/10; F16L 33/207; F16L 15/00

(57) ABSTRACT

A hose bib system includes a PEX plumbing line that may deliver a fluid. An adapter is provided and the adapter may be coupled to a vertical support surface. The adapter penetrates the vertical support surface. The PEX plumbing line is fluidly coupled to the adapter. A hose bib may be fluidly coupled to the adapter. Thus, the PEX plumbing line may deliver the fluid to the hose bib.

### BACKGROUND OF THE DISCLOSURE

Field of the Disclosure

The disclosure relates to hose bib devices and more particularly pertains to a new hose bib device for facilitating a solderless connection between a hose bib and a PEX plumbing line.

Summary of the Disclosure

An embodiment of the disclosure meets the needs presented above by generally comprising a PEX plumbing line that may deliver a fluid. An adapter is provided and the adapter may be coupled to a vertical support surface. The adapter penetrates the vertical support surface. The PEX plumbing line is fluidly coupled to the adapter. A hose bib may be fluidly coupled to the adapter. Thus, the PEX plumbing line may deliver the fluid to the hose bib.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a hose bib system according to an embodiment of the disclosure.

FIG. 2 is a back perspective view of an embodiment of the disclosure.

FIG. 3 is a front view of an embodiment of the disclosure.

FIG. 4 is a bottom view of an embodiment of the disclosure.

FIG. 5 is a cross sectional view of an embodiment of the disclosure.

### DESCRIPTION OF THE PREFERRED EMBODIMENT

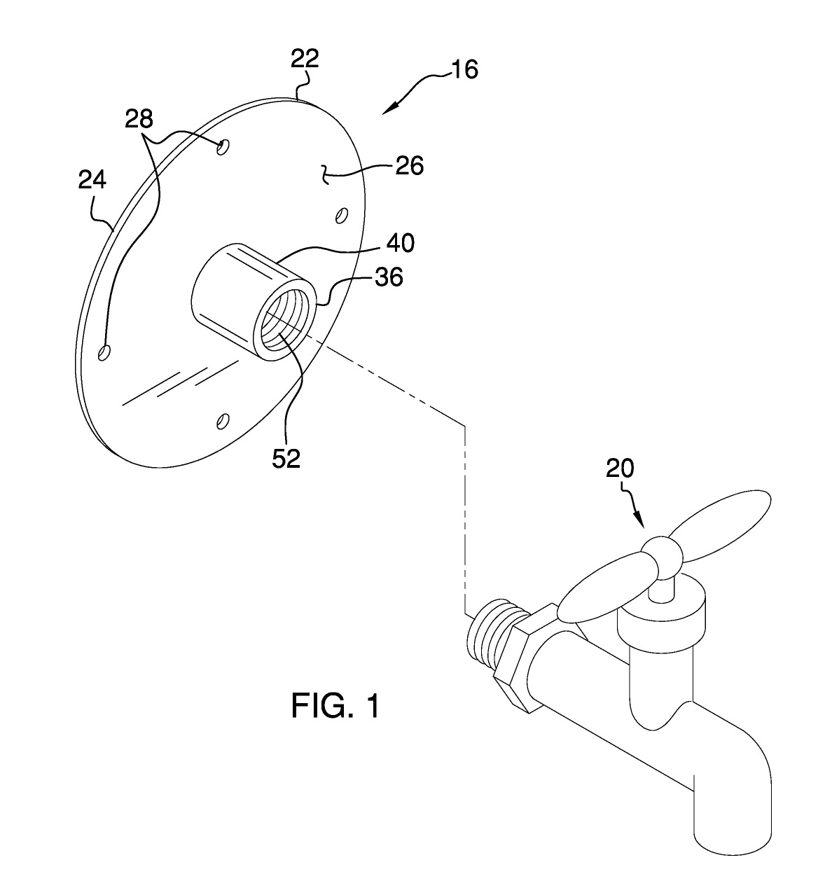

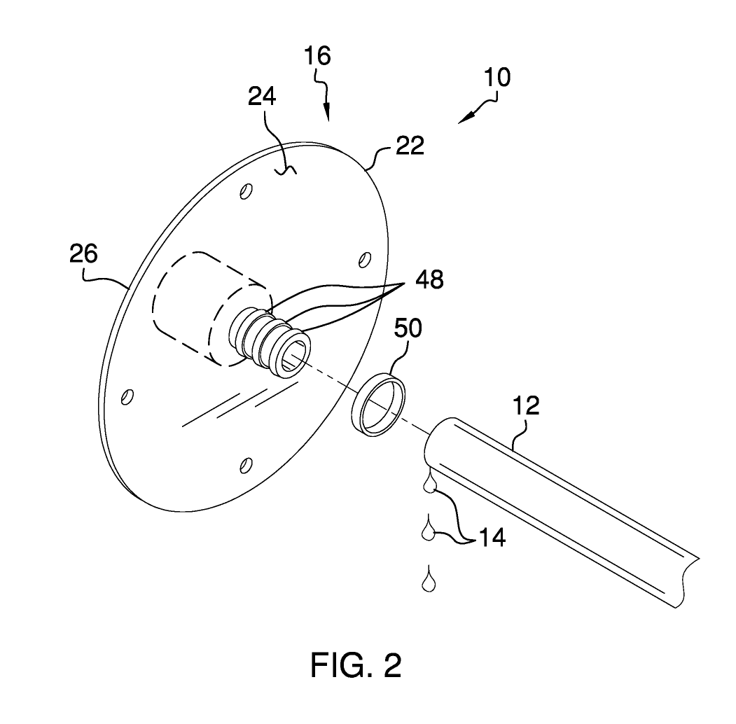

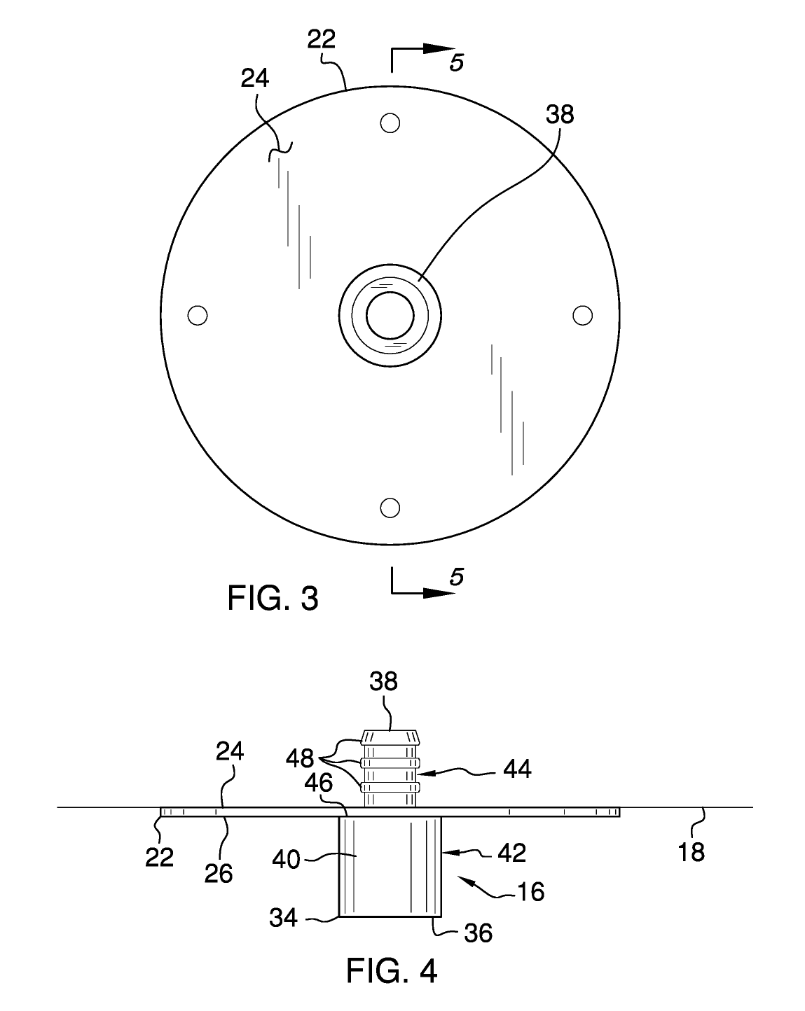

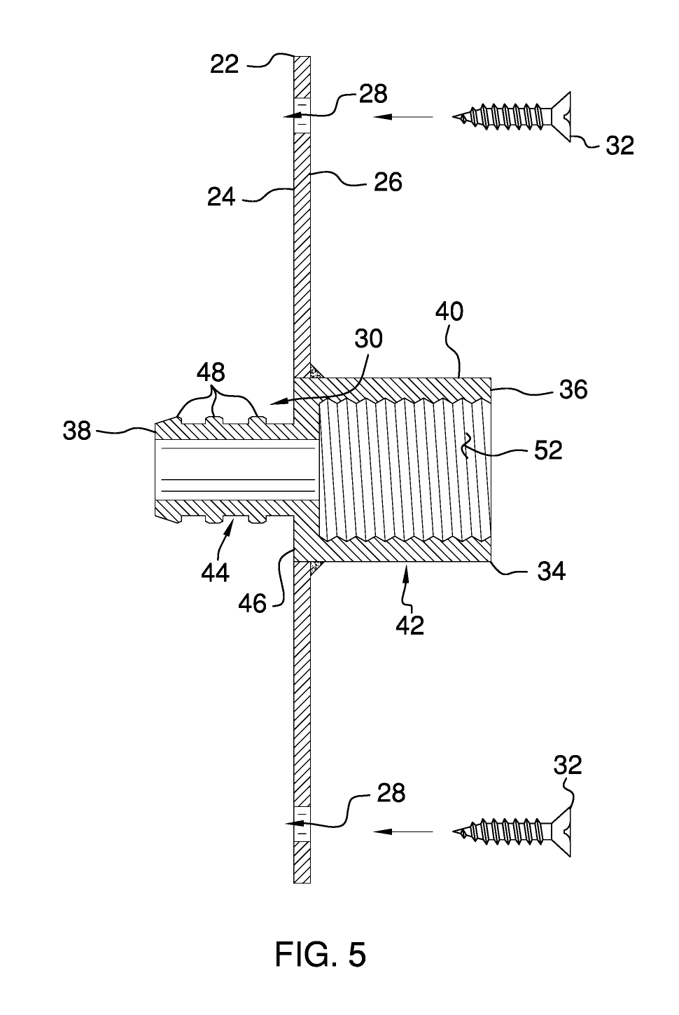

With reference now to the drawings, and in particular to FIGS. 1 through 5 thereof, a new hose bib device embodying the principles and concepts of an embodiment of the disclosure and generally designated by the reference numeral 10 will be described.

As best illustrated in FIGS. 1 through 5, the hose bib system 10 generally comprises a PEX plumbing line 12 that may deliver a fluid 14. The PEX plumbing line 12 may be a plumbing line in a building or the like. An adapter 16 is provided and the adapter 16 may be coupled to a vertical support surface 18. Thus, the adapter 16 may penetrate the vertical support surface 18. The vertical support surface 18 may be an exterior wall of the building or the like. Moreover, the exterior wall may comprise a masonry wall.

The PEX plumbing line 12 is fluidly coupled to the adapter 16. A hose bib 20 may be fluidly coupled to the adapter 16. Thus, the PEX plumbing line 12 may deliver the fluid 14 to the hose bib 20. The hose bib 20 may be a hose bib of any conventional design.

The adapter 16 comprises a plate 22 that has a first surface 24 and a second surface 26. The plate 22 has a plurality of openings 28 extending through the first surface 24 and the second surface 26. The openings 28 are spaced apart from each other and distributed around the plate 22. The plate 22 may have a disk shape and the first surface 24 abuts the vertical support surface 18. The plate 22 has an aperture 30 extending through the first surface 24 and the second surface 26. The aperture 30 is centrally positioned on the plate 22.

A plurality of screws 32 is provided. Each of the screws 32 extends through an associated one of the openings 28. Each of the screws 32 engages the vertical support surface 18. Thus, the plate 22 is retained on the vertical support surface 18.

A first fitting 34 is provided. The first fitting 34 has a first end 36, a second end 38 and an outer wall 40 extending between the first end 36 and the second end 38. The outer wall 40 is continuous such that the first fitting 34 has a cylindrical shape. Each of the first end 36 and the second end 38 are open and the first fitting 34 is substantially hollow.

The outer wall 40 has a first portion 42 and a second portion 44. The first portion 42 has a diameter that is greater than a diameter of the second portion 44. Thus, the first portion 42 has a bounding surface 46 extending between the first portion 42 and the second portion 44. The outer wall 40 corresponding to the second portion 44 has a plurality of ridges 48. Each of the ridges 48 extends completely around the second portion 44. The ridges 48 are spaced apart from each other and are distributed between the bounding surface 46 and the second end 38.

The first fitting 34 extends through the aperture 30. The bounding surface 46 may abut the second surface 26 of the plate 22. Thus, the second portion 44 may extend through the vertical support surface 18. The first portion 42 may be welded, soldered or braised to the plate 22. Thus, the first fitting 34 is coupled to the plate 22. The first fitting 34 may comprise a Viega Pex fitting manufactured by Viega LLC 100 N. Broadway, 6^{th} Floor, Wichita Kans., 67202.

The PEX plumbing line 12 insertably receives the second portion 44. Thus, the PEX plumbing line 12 is fluidly coupled to the first fitting 34. Each of the ridges 48 frictionally engages the PEX plumbing line 12. Thus, the PEX plumbing line 12 is inhibited from being removed from the first fitting 34. A crimp sleeve 50 is provided and the crimp sleeve 50 is crimped around the PEX pluming line 12. Thus, the PEX plumbing line 12 is coupled to the first fitting 34. The crimp sleeve 50 may comprise a PEX crimp sleeve or the like.

The first portion 42 of the first fitting 34 has an inside surface 52. The inside surface 52 is threaded. The hose bib 20 threadably engages the first portion 42. Thus, the hose bib 20 is fluidly coupled to the first fitting 34.

In use, a hole is cut or drilled through the vertical support surface 18. The PEX plumbing line 12 is extended through the hole. The PEX pluming line 12 is coupled to the first fitting 34. The plate 22 is coupled to the vertical support surface 18 and the screws 32 are manipulated to fasten the plate 22 to the vertical support surface 18. The PEX pluming line 12 is crimped to the first fitting 34 in the convention of PEX crimping. The hose bib 20 threadably engages the first fitting 34. Thus, the adapter 16 facilitates a solder free connection between the hose bib 20 and the PEX plumbing line 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hose bib system comprising:
a PEX plumbing line being configured to deliver a fluid; and
an adapter being configured to be coupled to a vertical support surface thereby facilitating said adapter to penetrate the vertical support surface, said adapter having said PEX plumbing line being fluidly coupled thereto, said adapter being configured to have a hose bib being fluidly coupled thereto thereby facilitating said PEX plumbing line to deliver the fluid to the hose bib.

2. The assembly according to claim 1, wherein said adapter comprises a plate having a first surface and a second surface, said plate having a plurality of openings extending through said first surface and said second surface, said openings being spaced apart from each other and being distributed around said plate, said first surface being configured to abut the vertical support surface, said plate having an aperture extending through said first surface and said second surface, said aperture being centrally positioned on said plate.

3. The assembly according to claim 2, further comprising a plurality of screws, each of said screws extending through an associated one of said openings wherein each of said screws is configured to engage the vertical support surface thereby facilitating said plate to be retained on the vertical support surface.

4. The assembly according to claim 1, further comprising a first fitting having a first end, a second end and an outer wall extending between said first end and said second end, said outer wall being continuous such that said first fitting has a cylindrical shape, each of said first end and said second end being open, said first fitting being substantially hollow, said outer wall having a first portion and a second portion, said first portion having a diameter being greater than a diameter of said second portion to define a bounding surface of said first portion.

5. The assembly according to claim 4, wherein said outer wall corresponding to said second portion has a plurality of ridges, each of said ridges extending completely around said second portion, said ridges being spaced apart from each other and being distributed between said bounding surface and said second end.

6. The assembly according to claim 5, wherein:
said adapter includes a plate, said plate having a second surface and an aperture; and
said first fitting extending through said aperture having said bounding surface abutting said second surface wherein said second portion is configured to extend through the vertical support surface, said PEX plumbing line insertably receiving said second portion such that said PEX plumbing line is fluidly coupled to said first fitting, each of said ridges frictionally engaging said PEX plumbing line such that said PEX plumbing line is inhibited from being removed from said first fitting.

7. A hose bib system comprising:
a PEX plumbing line being configured to deliver a fluid; and
an adapter being configured to be coupled to a vertical support surface thereby facilitating said adapter to penetrate the vertical support surface, said adapter having said PEX plumbing line being fluidly coupled thereto, said adapter being configured to have a hose bib being fluidly coupled thereto thereby facilitating said PEX plumbing line to deliver the fluid to the hose bib, said adapter comprising:
a plate having a first surface and a second surface, said plate having a plurality of openings extending through said first surface and said second surface, said openings being spaced apart from each other and being distributed around said plate, said first surface being configured to abut the vertical support surface, said plate having an aperture extending through said first surface and said second surface, said aperture being centrally positioned on said plate,
a plurality of screws, each of said screws extending through an associated one of said openings wherein each of said screws is configured to engage the vertical support surface thereby facilitating said plate to be retained on the vertical support surface,
a first fitting having a first end, a second end and an outer wall extending between said first end and said second end, said outer wall being continuous such that said first fitting has a cylindrical shape, each of said first end and said second end being open, said first fitting being substantially hollow, said outer wall having a first portion and a second portion, said first portion having a diameter being greater than a diameter of said second portion to define a bounding surface of said first portion, said outer wall corresponding to said second portion having a plurality of ridges, each of said ridges extending completely around said second portion, said ridges being spaced apart from each other and being distributed between said bounding surface and said second end, said first fitting extending through said aperture having said bounding surface abutting said second surface wherein said second portion is configured to extend through the vertical support surface, said PEX plumbing line insertably receiving said second portion such that said PEX plumbing line is fluidly coupled to said first fitting, each of said ridges frictionally engaging said PEX plumbing line such that said PEX plumbing line is inhibited from being removed from said first fitting, said first portion having an inside surface, said inside surface being threaded, said hose bib threadably engaging said first portion such that said hose bib is fluidly coupled to said first fitting.
